(19) United States
(12) Patent Application Publication
(10) Pub. No.: US 2014/0197279 A1
(43) Pub. Date: Jul. 17, 2014

(54) KITE

(71) Applicant: Fugett Jack, Mokena, IL (US)

(72) Inventor: Fugett Jack, Mokena, IL (US)

(21) Appl. No.: 13/739,443

(22) Filed: Jan. 11, 2013

(51) Int. Cl. B64C 31/06

(52) U.S. Cl. CPC B64C 31/06
USPC 244/153 R

(57) ABSTRACT

A kite includes a frame including first and second wings spaced apart along a vertical axis, wherein each of the first and second wings includes a leading edges and a trailing edge. The frame further includes a plurality of struts extending between and connecting the first and second wings.

### BACKGROUND

1. Field of the Invention

The present invention relates generally to a kite and, more particularly, to an aerodynamic kite.

2. Description of the Background

A conventional kite includes a frame, a sail or sheet of material covering the frame, and a line attached to the frame and extending away from the frame. The frame generally includes two linear posts that are tied, adhered, or otherwise attached to one another to generally form a T-shape. The sheet of material may be fabric or plastic and is generally diamond-shaped. Corners of the diamond-shaped sheet of material are attached to ends of the posts forming the frame to form the kite such that the sail is held completely flat against the frame. In use, a user grasps an end of the line remote from the kite to fly the kite.

### SUMMARY

In an illustrative embodiment, a kite comprises a frame including first and second wings spaced apart along a vertical axis, wherein each of the first and second wings includes a leading edges and a trailing edge The frame further includes a plurality of struts extending between and connecting the first and second wings, wherein the struts are pivotally connected to the first and second wings.

In a further illustrative embodiment, a kite comprises a frame including first and second wings spaced apart along a vertical axis, wherein each of the first and second wings includes a leading edge and a trailing edge. The frame further includes a plurality of struts extending between and connecting the first and second wings, wherein the wings and struts form opposing front and rear faces and opposing side faces of the frame. The kite further includes a wind tunnel attached to sides of the frame such that the wind tunnel covers the opposing side faces of the frame and extends longitudinally beyond the rear face of the frame. The wind tunnel has a first open end adjacent the frame and a second open end longitudinally spaced from the frame.

### BRIEF DESCRIPTION OF THE DRAWINGS

FIG. 1 is a top perspective view of a kite of the present invention, wherein the kite is attached by a string, wire, or other line to a pole;

FIG. 2 is a partial, enlarged view of a frame of the kite as indicated in FIG. 1;

FIG. 3 is a side elevational view of the kite of FIG. 1;

FIG. 4 is a top elevational view of the kite of FIG. 1;

FIG. 5 is a front elevational view of the kite of FIG. 1; and

FIGS. 6A and 6B are top perspective views of the kite of FIG. 1 with wings and transverse struts thereof pivoted along a lateral axis and a longitudinal axis, respectively.

Other aspects and advantages of the present invention will become apparent upon consideration of the following detailed description, wherein similar structures have like or similar reference numerals.

### DETAILED DESCRIPTION

The present invention is directed to kite. While the kite of the present invention may be embodied in many different forms, several specific embodiments are discussed herein with the understanding that the present invention is to be considered only as an exemplification of the principles of the invention, and it is not intended to limit the invention to the embodiments illustrated.

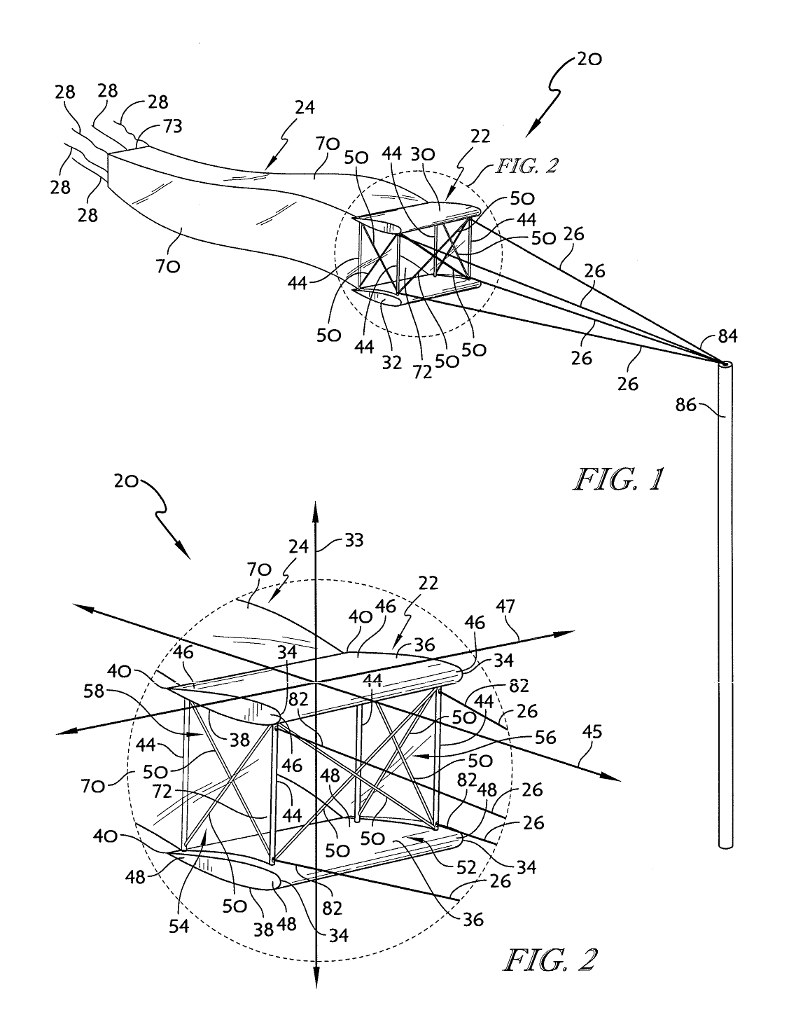

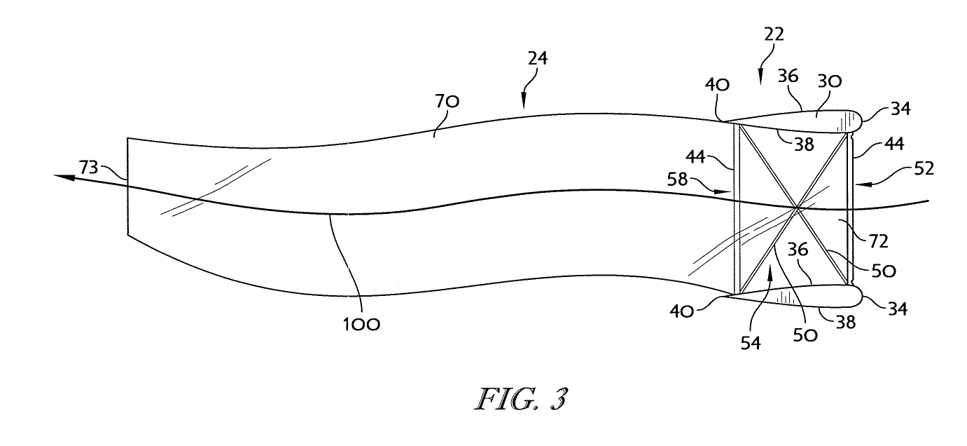

Referring to the drawings, FIGS. 1-5 depict a first embodiment of a kite 20 of the present invention. The kite 20 generally includes a frame 22, a wind tunnel 24, a line 26, and one or more optional tails 28. As best seen in FIG. 2, the frame 22 includes an upper wing 30 and a lower wing 32 spaced apart along a vertical axis 33 and connected by a plurality of struts, as discussed below. Each of the upper and lower wings 30, 32 includes a rounded leading edge 34, upper and lower cambered surfaces 36, 38, and a generally narrow and tapered trailing edge 40. The upper surfaces 36 of each wing 30, 32 may have the same or different camber and the lower surfaces 38 of each wing 30, 32 may have the same or different camber. Still further, the upper and lower surfaces 36, 38 of the upper wing 30 may have the same or different camber and/or the upper and lower surfaces 36, 38 of the lower wing 32 may have the same or different camber. As seen in FIG. 3, the wings 30, 32 are shaped to provide a positive pressure lifting action below each wing 30, 32 and a negative pressure lifting action from lowered pressure above each wing 30, 32. While a particular shape of wing 30, 32 is depicted, other wing shapes may be utilized without departing from the scope of the present invention.

As noted above, the wings 30, 32 are connected by a plurality of struts. In particular, the wings 30, 32 are connected by a plurality of transverse struts 44 that are generally perpendicular to the wings 30, 32 when the wings 30, 32 are in an unpivoted position, as will be discussed in greater detail hereinafter. While four transverse struts 44 are shown generally adjacent corners 46, 48 of the wings 30, 32, respectively, any number of transverse struts 44 may be utilized.

Each of the transverse struts 44 is pivotally connected to each of the wings 30, 32. In an illustrative embodiment, each of the transverse struts 44 is connected to each of the wings 30, 32 by a hinge, a ball and socket joint, a pin, or any other suitable pivot joint or structure that would allow the transverse struts 44 to pivot with respect to the wings 30, 32. In illustrative embodiments, the pivot joints may allow the transverse struts 44 to pivot from front to back along a longitudinal axis 45 and/or from side to side along a lateral axis 47. In another illustrative embodiment, the pivot joints may allow the transverse struts 44 to pivot about an indefinite number of axes (e.g., through a ball and socket joint). In yet another illustrative embodiment, the pivot joints may allow the transverse struts 44 to pivot about any number of axes. Each of the struts 44 may be connected to the wings 30, 32 by the same or different pivot joints.

As best seen in FIG. 2, the frame 22 further includes a plurality of diagonal struts 50 pivotally connected to the transverse struts 44. Specifically, diagonal struts 50 are shown as connecting the transverse struts 44 adjacent a front face 52 of the frame 22, as seen in FIG. 5. Diagonal struts 50 are also shown as connecting the transverse struts 44 adjacent a first side face 54 and a second side face 56 of the frame 22, as seen in FIG. 3 (only the first side face 54 is shown, but the second side face 56 is a mirror image of the first side face 54). Optionally, although not shown, diagonal struts 50 may connect the transverse struts 44 adjacent a rear face 58 of the frame 22. The diagonal struts 50 are positioned to prevent the kite 20 from collapsing and to better space and position the wings 30, 32 with respect to one another.

In an illustrative embodiment, the diagonal struts 46 may be connected to the transverse struts 44 by a hinge, ball and socket joint, a pin, or any other suitable pivot joint or structure that would allow the diagonal struts to pivot with respect to the transverse struts 44, as will be discussed in greater detail below.

In illustrative embodiments, the wings 30, 32 of the frame 22 may be made of a semi-rigid material, for example, fabric, plastic, metal, or any other suitable material. In illustrative embodiments, the struts may be made of plastic, wood, metal, or any other suitable material.

Referring to FIGS. 1, 3, and 4, the wind tunnel 24 is joined to the wings 30, 32 and the wind tunnel 24 extends beyond the rear face 58 of the frame 22. The wind tunnel 24 may be made of fabric, nylon, paper, vinyl plastic, or any other suitable material. The wind tunnel 24 may be attached to the struts 44, 50 and/or wings 30, 32 in any suitable fashion, for example, hook and loop fasteners, adhesive, and/or hooks. While the transverse and diagonal struts 44, 50 are visible in the figures, depending on the material utilized for the wind tunnel 24, the struts 44, 50 may not be visible through the material of the wind tunnel 24. In an illustrative embodiment, the wind tunnel 24 may be formed of a translucent or transparent fabric. In another illustrative embodiment, the wind tunnel 24 may be made of a solid fabric material that hides the struts 44, 50.

As seen in FIGS. 1-3 and 4, in an illustrative embodiment, the wind tunnel 24 may be attached to the lower surface 38 of the upper wing 30 and the upper surface 36 of the lower wing 32 and/or to front and rear transverse struts 44 and/or the diagonal struts 50. Regardless of what structure(s) the wind tunnel 24 is attached to, the wind tunnel 24 covers the first and second side faces 54, 56 of the frame 22. The wind tunnel 24 also extends beyond the rear face 58 of the frame 22 and includes four sides 70, a first open end 72 adjacent the frame 22, and a second open end 73 opposite the frame 22. In an illustrative embodiment, the wind tunnel 72 is between about 2 feet and about 8 feet long. While four sides 70 are shown, the wind tunnel 24 may have any other suitable number of sides.

As best seen in FIG. 1, the kite 20 may include one or more optional tails 28 connected to and extending from the wind tunnel 24 (or the frame 22). The tails 28, if utilized, may be sewn, adhered, or otherwise attached to the second open end 73 of the wind tunnel 24. The one or more tails 28 may be made of long, narrow, strips of plastic, fabric, or any other suitable flexible material. The one or more tails 28 may provide stability to the kite 20 and/or orient the kite 20 with the leading edges 34 of the wings 30, 32 pointing into the wind. Alternatively or optionally, the one or more tails 28 may be utilized for decorative purposes.

Referring again to FIG. 1, the kite 20 includes one or more lines 26 that extend from the frame 22. The lines 26 are attached at a first end 82 to the frame 22. In an illustrative embodiment, the kite 20 includes four lines 26 attached to the transverse struts 44 forming the front face 52 of the frame 22. In further illustrative embodiments, the lines 26 may be attached to the transverse struts 44, the diagonal struts 50, and/or the wings 30, 32. The lines 26 may be attached to any of such structures in any suitable manner.

In an illustrative embodiment, the lines 26 may be attached at a second end 84 to a pole, post, or other stationary structure 86, as seen in FIG. 1. In a further illustrative embodiment, one or more of the lines 26 may be attached at the second end 84 to a handheld reel or winder (not shown) or simply held by a user. The one or more lines 26 may be made of wood, plastic, metal, rope, or combinations thereof Further, if more than one line 26 is used, the lines may be of different materials. If used, the reel or winder may be held by a user and may include a projecting fork or other structure for winding the lines 26 therearound to vary a length of the lines 26 between the reel or winder and the frame 22. In a further illustrative embodiment, if multiple lines 26 are utilized, the lines 26 may be joined at a transition point between the frame 22 and the reel or winder and a single line may extend from the transition point to the reel or winder such that a single line is wound around the reel or winder. Optionally, any other reel, winder, or structure for holding an end of one or more of the lines 26 may be utilized.

In operation, the kite 20 is either attached by the line(s) 26 to the stationary structure 86 or the line(s) 26 are held by a user. As air moves around the kite 20, the shape of the wings 30, 32, causes air to move more quickly over the wings 30, 32, than it does under the wings 30, 32. As the wings 30, 32 move, the air flowing over the wings 30, 32 has farther to go and it moves faster than the air underneath the wings 30, 32, thereby causing the air pressure above the wings 30, 32 to be less than below the wings 30, 32 to produce an upward lift. Deflection around the leading edges 34 of the wings 30, 32 also causes drag along the direction of the wings 30, 32. A resultant force from the lift and drag force components is resisted by the tension created in the one or more lines 26, thereby keeping the kite 20 in the air and moving in different directions depending on the wind.

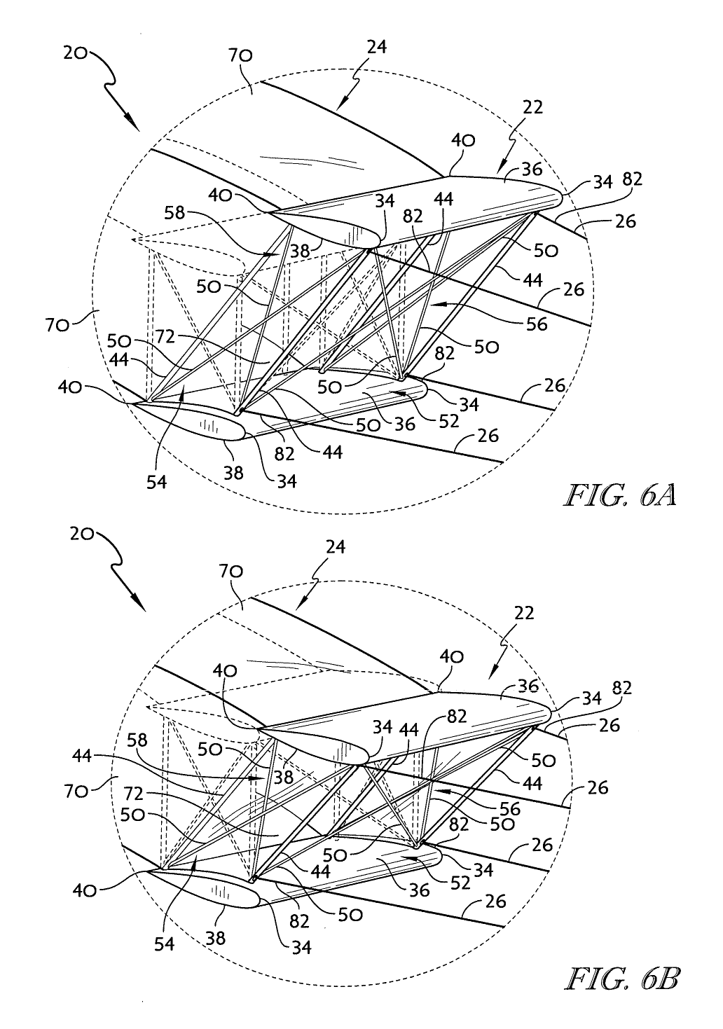

Depending on the shifting of the wind, the wings 30, 32, and thus the kite 20, may move up and down, from left to right, and/or may turn. As this occurs, the transverse struts 44 pivot with respect to the wings 30, 32, for example, as seen in FIG. 6. In particular, as the air pressure around each of the wings 30, 32 changes, one or both of the wings 30, 32 may move in different directions to keep the leading edges 34 of the wings 30, 32 pointing into the wind. FIGS. 6A and 6B depicts an illustrative embodiment wherein each of the transverse struts 44 is connected to each wing 30, 32 by a ball and socket joint. FIGS. 6A and 6B further depict rotation about the joints such that the wings 30, 32 are no longer vertically aligned. Rather, the wings 30, 32 are staggered along the lateral axis 47 or rotated in the direction of the lateral axis 47, as seen in FIG. 6A, and the wings 30, 32 are staggered along the longitudinal axis 45 or rotated in the direction of the longitudinal axis 45, as seen in FIG. 6B. Optionally, the wings 30, 32 may be staggered along both the longitudinal axis 45 and the lateral axis 47.

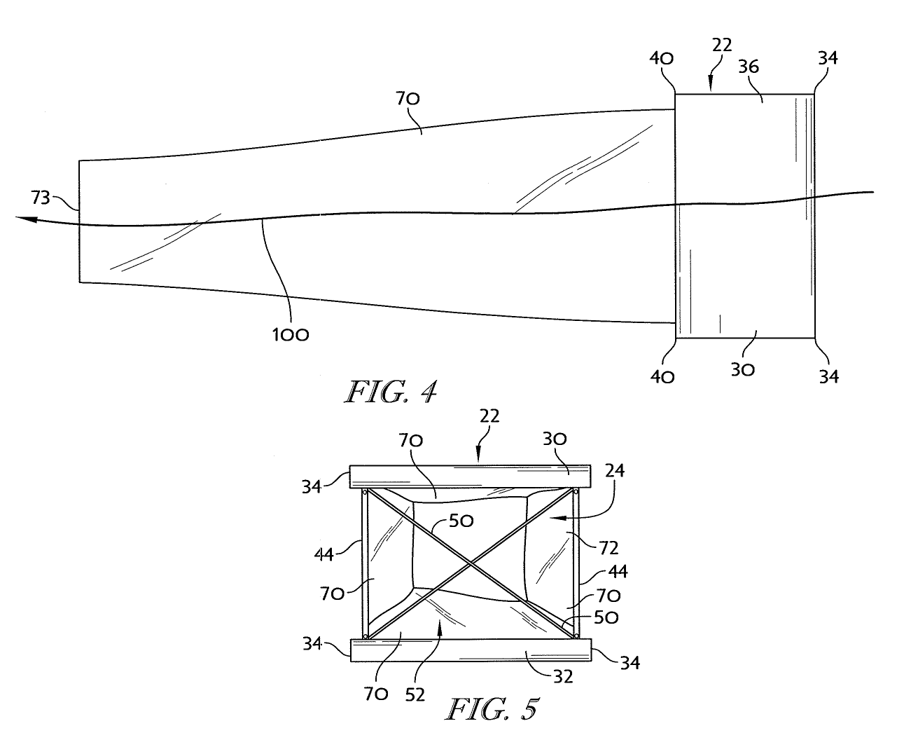

As depicted in FIGS. 3 and 4 by the line 100, wind enters the front face 52 of the frame 22 of the kite 20 and travels through the frame 22. The wind thereafter travels through the wind tunnel 24 and out the second end 73 of the wind tunnel 24, which functions to stabilize the wings 30, 32.

Any of the embodiments described herein may be modified to include any of the structures or methodologies disclosed in connection with other embodiments.

Further, although directional terminology, such as front, back, top, bottom, upper, lower, etc. may be used throughout the present specification, it should be understood that such terms are not limiting and are only utilized herein to convey the orientation of different elements with respect to one another.

All documents cited in the Detailed Description are, in relevant part, incorporated herein by reference; the citation of any document is not to be construed as an admission that it is prior art with respect to the present disclosure.

Numerous modifications to the present disclosure will be apparent to those skilled in the art in view of the foregoing description. Accordingly, this description is to be construed as illustrative only and is presented for the purpose of enabling those skilled in the art to make and use the embodiments of the disclosure and to teach the best mode of carrying out same. The exclusive rights to all modifications which come within the scope of the appended claims are reserved.

I claim:

1. A kite, comprising:
a frame comprising
first and second wings spaced apart along a vertical axis, wherein each of the first and second wings includes a leading edge and a trailing edge; and
a plurality of struts extending between and connecting the first and second wings, wherein the struts are pivotally connected to the first and second wings.

2. The kite of claim 1, wherein the struts are pivotally connected to the first and second wings by ball and socket joints or hinges.

3. The kite of claim 1, wherein the struts are made of plastic, wood, or metal.

4. The kite of claim 1, further including a plurality of diagonal struts pivotally connected to the struts.

5. The kite of claim 1, wherein the leading edge of each wing is rounded and the trailing edge of each wing is narrow and tapered.

6. The kite of claim 1, wherein the wings and struts form opposing front and rear faces and opposing side faces of the frame and the kite further includes a wind tunnel attached to the frame and extending longitudinally beyond the rear face of the frame.

7. The kite of claim 6, wherein the wind tunnel is attached to the frame to cover each of the side faces.

8. The kite of claim 7, wherein the wind tunnel is made of fabric, nylon, paper, vinyl, or plastic.

9. The kite of claim 7, further including at least one tail attached to and extending from an end of the wind tunnel opposite the frame.

10. The kite of claim 1, further including a line extending from the frame for attaching to a stationary object or for grasping and moving by a user.

11. The kite of claim 1, wherein the wings are made of fabric or plastic.

12. A kite, comprising:
a frame comprising
first and second wings spaced apart along a vertical axis, wherein each of the first and second wings includes a leading edge and a trailing edge; and
a plurality of struts extending between and connecting the first and second wings,
wherein the wings and struts form opposing front and rear faces and opposing side faces of the frame; and
a wind tunnel attached to sides of the frame such that the wind tunnel covers the opposing side faces of the frame and extends longitudinally beyond the rear face of the frame, wherein the wind tunnel has a first open end adjacent the frame and a second open end longitudinally spaced from the frame.

13. The kite of claim 12, wherein the leading edge of each wing is rounded and the trailing edge of each wing is narrow and tapered.

14. The kite of claim 12, further including a plurality of diagonal struts pivotally connected to the struts, wherein the struts are pivotally connected to the first and second wings to allow the first and second wings to move out of alignment with one another along a vertical axis.

15. The kite of claim 12, further including at least one tail attached to and extending from an end of the wind tunnel opposite the frame.

16. The kite of claim 12, further including a line extending from the frame for attaching to a stationary object or for grasping and moving by a user.

17. The kite of claim 12, wherein the struts are pivotally connected to the first and second wings by ball and socket joints or hinges.

18. The kite of claim 12, wherein the struts are made of plastic, wood, or metal.

19. The kite of claim 12, wherein the wind tunnel is made of fabric, nylon, paper, vinyl, or plastic.

20. The kite of claim 12, wherein the wings are made of fabric or plastic.
